(19) United States
(12) Patent Application Publication
(10) Pub. No.: US 2011/0246287 A1
(43) Pub. Date: Oct. 6, 2011

(54) SYSTEM AND METHOD FOR MANAGING A MARKETING CAMPAIGN

(76) Inventors: JOSEPH P. WRIGHT, Melbourne, FL (US); Karl E. Williams, Arlington, VA (US)

(21) Appl. No.: 12/752,464

(22) Filed: Apr. 1, 2010

(51) Int. Cl. G06Q 30/00; G06Q 99/00; G06Q 10/00

(52) U.S. Cl. 705/14.45

(57) ABSTRACT

A method for implementing a campaign can include registering in a database each of a plurality of registered users to receive notifications sent on behalf of a business customer. A given campaign can be created for the business customer by storing campaign data that parameterizes at least timing and content for the given campaign. In response to determining to begin distribution of the campaign based on the campaign data, a unique campaign code associated with the given campaign can be sent to a point-of-sale (POS) system to enable tracking of transactional activity motivated by the campaign. At least one notification can also be sent to each of the plurality registered users about the campaign. The notification further can include an offer code that is based on at least a portion of the unique code associated with the given campaign.

### TECHNICAL FIELD

The invention relates generally to a system and method for managing a marketing campaign.

### BACKGROUND

A general goal of any business, including and especially retail businesses, is to entice or encourage potential customers to purchase products and services. To this end, various retail merchants publish advertisements over a variety of different types of media. Examples of such media can include printed advertisements (e.g., in newspapers and magazines, signs), direct marketing advertisements that can be sent to prospective customers via electronic and physical transport, as well as advertisements on the Internet. Many of the advertising methods are directed to the general public and, therefore, are often ignored by potential customers as corresponding to spam or junk mail.

### SUMMARY

The invention relates generally to a system and method for managing a marketing campaign.

One aspect of the invention provides a method for implementing a campaign. The method can include registering in a database each of a plurality of registered users to receive notifications sent on behalf a customer. A given campaign can be created for the business customer by storing campaign data that parameterizes at least timing, and content for the given campaign. Campaign data can also specify one or more locations for the campaign. In response to determining to begin distribution of the campaign based on the campaign data, a unique campaign code associated with the given campaign can be sent to a point-of-sale (POS) system to enable tracking of transactional activity motivated by the campaign. At least one notification can also be sent to each of the plurality registered users about the campaign. The notification further can include an offer code that is based on at least a portion of the unique code associated with the given campaign.

Another aspect of the invention provides a system for managing a campaign. The system can include a campaign manager that comprises program instructions executable by a server. Thus the server can perform a method that includes storing campaign data in a data store in response to a request from a business customer. The campaign data includes rules for implementing at least one given campaign on behalf of the business customer. The server can also perform a method that includes sending a campaign code associated with the given campaign to at least one point-of-sale (POS) system to enable tracking of transactional activity related to the at least one given campaign. Another method of the server can include causing at least one notification to be sent to each of a plurality registered users about the campaign, the notification comprising an offer code that is part of the at least one given campaign. The notification can also include other information (e.g., text, graphics or the like) about the campaign. The POS system can be configured to conduct a transaction involving presentation of the offer code by a given one of the registered users as part of the given campaign.

### BRIEF DESCRIPTION OF THE DRAWINGS

FIG. 1 is a flow diagram depicting a method of implementing a marketing campaign according to an aspect of the invention.

FIG. 2 depicts an example platform that can be implemented according to an aspect of the invention.

FIG. 3 depicts an example of a platform for implementing a social networking marketing campaign according to an aspect of the invention.

FIG. 4 depicts an example of a platform for implementing a pre-ordering campaign according to an aspect of the invention.

FIG. 5 depicts an example of a website that can be utilized as part of a pre-ordering campaign according to an aspect of the invention.

FIG. 6 depicts an example of a login graphical user interface that can be implemented as part of a pre-ordering campaign according to an aspect of the invention.

FIG. 7 of a pre-order menu that can be utilized as part of a pre-ordering campaign according to an aspect of the invention.

FIG. 8 depicts an example of an order placement graphical user interface that can be implemented as part of a pre-ordering campaign according to an aspect of the invention.

FIG. 9 depicts an example of an order verification graphical user interface that can be implemented as part of a pre-ordering campaign according to an aspect of the invention.

FIG. 10 depicts an example of a platform for implementing an in-event ordering campaign according to an aspect of the invention.

FIG. 11 depicts an example of a first graphical user interface that can be implemented as part of an in-event ordering campaign according to an aspect of the invention.

FIG. 12 depicts an example of a second graphical user interface that can be implemented as part of an in-event ordering campaign according to an aspect of the invention.

FIG. 13 depicts an example of a third graphical user interface that can be implemented as part of an in-event ordering campaign according to an aspect of the invention.

FIG. 14 depicts an example of a fourth graphical user interface that can be implemented as part of an in-event ordering campaign according to an aspect of the invention.

FIG. 15 depicts an example of a fifth graphical user interface that can be implemented as part of an in-event ordering campaign according to an aspect of the invention.

### DETAILED DESCRIPTION

The invention relates to systems and methods system and method for managing a marketing campaign. The systems and methods provide a mechanism that can leverage new and existing technologies (e.g., social networking services) and thereby provide an interface between a business customer and an identifiable set of users. The users are identifiable since the system and method provide one or more offerings to any user (e.g., a consumer or potential consumer) that has registered (e.g., opted in) to receive such offerings. That is, by virtue of their registration, each registered user has elected to receive offerings sent on behalf of a specific business customer. As a result, the business customer is in a unique position to anticipate the needs and wants of such consumers and satisfy their needs and wants more effectively when implementing a given campaign.

As used herein a “business customer” is intended to encompass any entity that can have a relationship that affords an opportunity to utilize systems and methods described herein. As one example, a business customer can refer to a provider of goods, services or goods and services. For instance, a “business customer” can own and/or manage one or more of a retail store, a restaurant, concessionaire, or other station via which goods and/or services are sold or distributed to consumers thereof. Each of the points of sale for a given business customer can be co-located at a common venue or be distributed across a number of one or more different geographic locations. Additionally or alternatively, a “business customer” can refer to a third party (e.g., an organization or service) that is utilized by an organization to operate a portion of a business and/or to implement one or more campaigns. For instance, various types of businesses (e.g., in the food service and hospitality industries) may contract with a third party company to manage or run a portion or all of a facility, such as related to inventory, shipment of goods and associated services, and marketing thereof. Such a third party can thus operate as a “business customer” in the systems and methods herein.

As used herein the term “campaign” can refer to a marketing campaign, which can encompass one or more of creating, communicating, delivering, and fulfilling offerings. The offering for a given campaign can vary according to the purpose and parameters of the campaign defined by the business customer. One or more different types of campaigns can be implemented, such as, for example, offers or incentives to potential customers and contests that allow one or more customer to win a prize. The invention provides a mechanism that enables business customers to generate revenue and increase customer satisfaction with very little, if any, overhead. The systems and methods disclosed herein can leverage emerging technologies (e.g., social networking services) to contact a relevant population base that extends the customer's presence while rewarding their customer base.

As an example, the systems and methods described herein can be implemented in the context of an event venue (e.g., an arena, stadium, hall, hotel or conference center, park or the like), such as may be utilized by one or more sporting teams, promotional businesses or other provider of hospitality or entertainment services. Systems and methods further can be configured to interface with one or more social networking services to send offers and related information to the registered users (e.g., consumers and other attendees of the event venue) by contacting such individuals with offers outside the traditional confines of the venue's physical premises.

As will be appreciated by those skilled in the art, portions of the invention may be embodied as a method, data processing system, or computer program product. Accordingly, these portions of the present invention may take the form of an entirely hardware embodiment, an entirely software embodiment, or an embodiment combining software and hardware. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments of the invention are described herein with reference to flowchart illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks. It is to be understood and appreciated that the illustrated actions; in other embodiments, may occur in different orders or concurrently with other actions different from that shown and described herein.

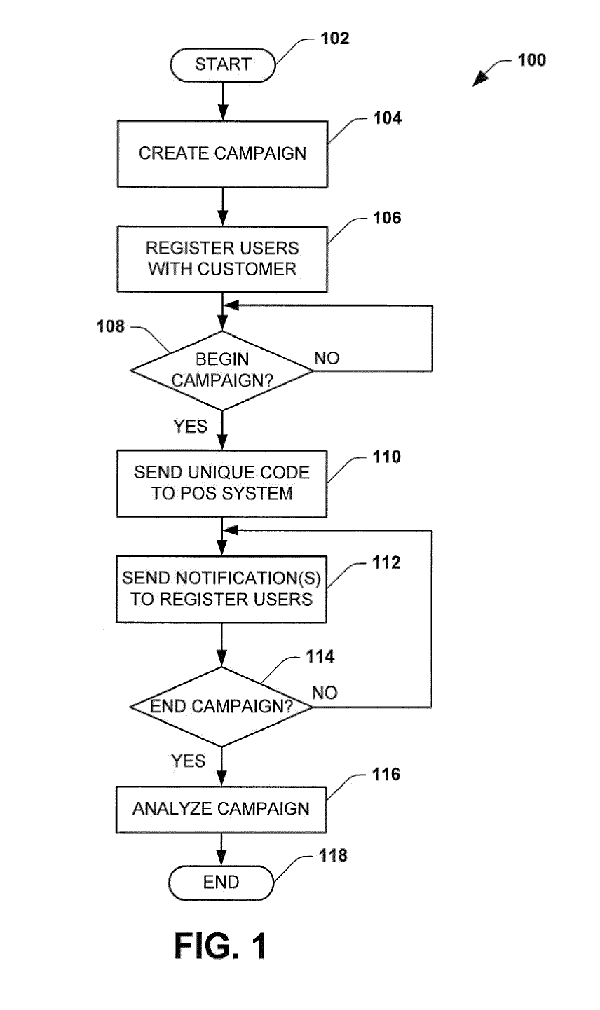

FIG. 1 depicts an example of a method 100 that can be implemented according to an aspect of the invention. The method begins 102 such as in conjunction with activating services that are programmed to manage a campaign. Such services can include applications and modules that cooperate to register business customers, such as can include signing up and creating a customer account via which the customer can create any number of one or more campaigns. As used herein, it will be understood and appreciated that a campaign can be defined for any number of one or more stores or retail stations that may be owned by, controlled, or otherwise accessible by the business customer. Such store, retail station or the like can include physical premises as well as on-line store services. Thus, at 102, the business customer account is established in a database and is assigned a unique customer identification code, which may vary depending on the customer name. Store level details associated with each location can also be stored as part of the business customer account data, including individual codes for each store. The database can, for example, store the codes that are used internally by the business customer to maintain consistency with the semantic relationships established by the customer, or unique codes can be generated for use in implementing the method 100. The type of POS system for each location can be specified to facilitate management and control at the POS server and workstation levels. The POS information (e.g., manufacturer and model number, software version) can be utilized to access proper technical specifications and rules for constructing interfaces and instructions in a proper format. For example, such interfaces can be utilized as part of the method to enable communication with the POS systems to control keys and other processes for performing business transactions as part of a campaign.

At 104, a campaign can be created for a business customer. It will be understood and appreciated that there can be many types of campaigns. By way of example, the campaign can be categorized generally as incentives, contests and ad hoc campaigns. When a campaign is created, the type of campaign, which may involve more than one type of the above-mentioned campaigns, can be specified. Various types of information can be specified for creating a given campaign, which further may vary according to the campaign type. For each campaign that is created by a business customer, a unique identifier or campaign code is generated as part of the campaign creation (at 104). Various other types of codes and tracking information can be derived from the unique code that is generated for the given campaign, such as described herein.

At 106, users are registered to receive notifications and offers for one or more campaign that is created (at 104) by the business customer. That is, for an individual to receive notifications for a given campaign, a given user must be registered to receive such notifications. Such registration is often referred to as opting in. It will be appreciated that the registration need not be limited to a given campaign, but instead can be applicable for any and all campaigns that might be initiated by the business customer. That is, the registration represents an affirmation by the user to receive notifications associated with (e.g., originating from and/or approved by) a given business customer. For example, a user can register to receive notifications for a favorite sports team and, as a result of such registration, may receive notifications relating to tickets or special team events, and other notifications relating to food and beverages at the teams home venue. The notifications relating to tickets or special events can be part of the same or a different campaign from the notifications about food and beverages.

The business customer or an affiliate thereof can solicit potential users in a variety of contexts to encourage users to become registered users. An example, such solicitations can be provided in emails or as links on a web page, which can provide a uniform resource locator (URL) that the user can follow to an active server page (ASP) programmed to register the user to receive offers. For instance, the link can be made available by the business customer's home web page, from a third-party web page or through other mechanisms that can be followed by a user to access the registration page.

Part of the user registration process at 106 can include receiving and storing in a campaign database personal information for the user as well as contact information for receiving notifications. The contact information can be utilized for sending notifications to the customer associated with one or more campaign implemented by the business customer. As an example, the user can specify one or more preferred social networking service through which the campaign notifications can be sent. For a specified social networking service, a user will provide their account name (e.g., or other account identifier). After the request for registration has been submitted as part of the registration process, the user will receive a confirmation that the request has been submitted, which can be provided via the identified social networking service or by the service through which the registration is being implemented. After registered for the selected business customer, a potential customer can be presented an option to register to receive offers from additional business customers that may be relevant to the individual based upon their profile (e.g., the individual's profile maintained in the campaign database and/or their social networking profile).

At 108, the determination is made as to whether the campaign has begun, which the determination can be based on parameters defined in the campaign created at 104. Thus, once a campaign begins, the method proceeds to 110. At 110, the unique code that is generated with the creation of the campaign at 104 is sent to one or more POS system. The unique code can thus be provided through corresponding POS interfaces in a format suitable for each POS system to which the code is sent. The location and type for each of the POS systems are defined in the campaign parameters. Each campaign can include its own unique code to facilitate analysis and tracking of the campaign.

At 112, one or more notifications are sent to each user that is registered to receive notifications or offers from the business customer that created the campaign at 104. The notification, for example, can include an offer as well as specify a time period during which the offer is valid. In order to facilitate tracking of the campaign, the notification can also include a corresponding offer code. The offer code can be generated from or be included in the unique code that is sent to the POS system (at 110) for the corresponding campaign.

In addition to sending notifications to the individual users that are registered, corresponding notifications can be sent to various types displays, such as in the form of information, advertisements or solicitations relevant to the campaign. The particular content of such notifications can vary depending on the type of the campaign. As one example, a notification for a given campaign can be sent to a digital signage system to inform the corresponding portion of the public that the given campaign exists as well as to inform the potential users of possible benefits to them. Such a digital signage display can also provide instructions about how a user can become a registered user and thereby receive notifications and the associated benefits. Additionally, one or more notifications can be sent at desired times specified in the campaign parameters, which can be specified by the business customer when the campaign is created or be modified after campaign creation.

For an ad hoc campaign, notifications, including offers, can be sent in real time or substantially real time to registered users substantially concurrently with the creation of the campaign. That is, an ad hoc campaign can be created and implemented at any time. For example, an ad hoc campaign can be created and began during an event (e.g., a sporting event, a concert or the like) to present offers to registered users to facilitate or motivate purchases of particular goods or services. Alternatively or additionally, an ad hoc campaign can be utilized to encourage or motivate registered users to make purchases of such goods or services from a specified location. For instance, at an event, a particular concession area may be underutilized and have excess inventory that the business customer wishes to sell prior to the end of the event. Accordingly, a campaign can be created to send an offer to customers advising them that discounted merchandise or food items can be purchased from such locations. The notification that includes the offer can also include an offer code that the user can present at the time of purchase to redeem the offer. The offer code would also be sent concurrently to the POS system at 110, such as to facilitate tracking of the campaign's success.

At 114 a determination is made as whether the campaign has ended. If the campaign has not ended, the method can return to 112 or, in the event that additional items are offered during the campaign, such as part of an ad hoc campaign, the method can return to 110. If the campaign has ended, the method proceeds from 114 to 116 in which the campaign is analyzed. The analyzing of the campaign can be based on monitoring tracking (e.g., offer) codes that were provided with the notifications (at 112) and were entered at the POS system in response to financial activity and transactions. As mentioned, the same tracking code can be sent to each registered user since the goal is to understand the results of the campaign (not individual user circumstances). As the campaign is analyzed additional campaigns can be created based on the results of a given campaign or based on a series of campaigns implemented by a business customer such as to increase the effectiveness of subsequent campaigns. The method ends at 118.

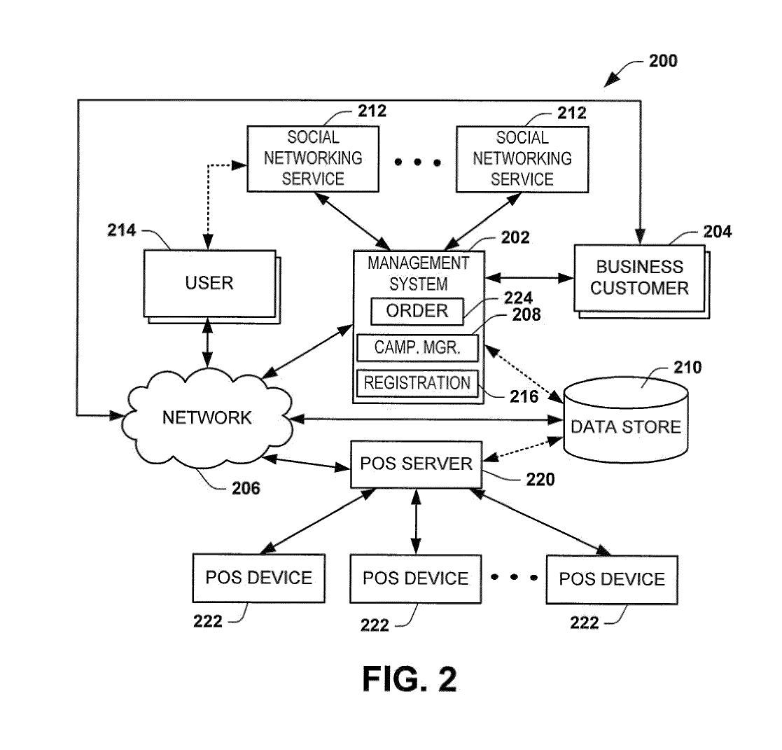

FIG. 2 depicts an example of a platform 200 that can be implemented according to an aspect of the invention. The platform 200 includes a management system 202 that operates as an interface between business customers and users, which are registered to interact with such business customers. The management system 202 does this by providing corresponding programmatic interfaces to facilitate the creation of campaigns and dissemination of campaign related information provided by a business customer. Additionally, the management system 202 can include interfaces to enable and to facilitate transactional interactions related to a campaign to occur between registered users and business customers.

For example, a business customer 204 can communicate with the management system 202 via a network 206. The business customer 204 can utilize any network-compatible device, which can be configured to communicate with the network 206 via a physical link, a wireless link or a combination of physical and wireless communication links. The network 206 can include a local area network (LAN), wide area network (WAN), such as the internet, or a combination of network topologies, which may be include physical, wireless or physical and wireless technologies. The network 206 can further provide a secure or encrypted link between the business customer 204 and the management system 202.

The management system 202 can be programmed as a service or services that can provide a plurality of related graphical user interfaces (GUIs) to the business customer 204 via the network, such as in the form of web pages (e.g., HTML, dynamic HTML, or the like). The various GUIs can be programmed to facilitate creation of a campaign for achieving a desired business purpose. The management system 202 thus includes a campaign manager 208. The campaign manager 208 can include applications and components programmed for creating and implementing a campaign based upon information entered by the business customer 204. It will be understood and appreciated that any number of one or more devices can be utilized by any number of business customers 204 for creating corresponding campaigns. The management system 202 can provide a shared platform that can be utilized by any number of different business customers 204.

Information and parameters that define a given campaign can be stored in a data store 210. The data store can be part of or in communication with the management system 202 either directly (indicated by a dotted line) or through the network 206. For instance, a data server (not shown) can be implemented for controlling storage and retrieval of information in the data store 210.

As an example, the business customer 204 can employ the campaign manager 208 to request and create a corresponding campaign to achieve a desired business objective. The campaign manager 208 further can include or utilize an interface to one or more social networking services 212. For instance, the management system 202 can register as a user or register on behalf of each business customer 204 as a user for any number of one or more of the social networking services 212. As such, the campaign manager 208 can leverage the social networking services 212 to send notifications to any number of one or more users that have been registered to receive such notifications from the business customer for which a given campaign has been created. That is, the campaign manager 208 can operate as a proxy or employ a predetermined service that is configured to distribute campaign notifications through the social networking services 212 to register users.

The management system 202 can also include a registration component 216 that is programmed to collect and store information that is required for communicating with such users via the social networking services 212. For instance, each user 214 can access the registration component 216 via a corresponding user device as part of a registration process. The user 214 can access a registration web page via the network 206 through a secure connection, such as by activating a link to a URL that is controlled by the registration component 216. The secure web page can request that the user 214 register the user's existing account information, which can include identifying a preferred social networking service 212.

For example, the registration component 216 can be implemented as a web service that presents the user 214 with a GUI corresponding to a Tillable form into which the user can provide basic information during the registration process that is stored in the data store 210. For instance, the information can include: First and last name, a preferred social networking means of contact (e.g., FaceBook, Twitter, Bebo, MySpace, LinkedIn, Nexopia, StudiVZ, Tagged, XING, SMS text message, email, or the like), and the account name associated with the preferred means of contact (e.g., a Twitter account name). A telephone number can be requested if the customer chooses SMS messaging to be used as a means of contact. It will be appreciated that instead of using the registration component 216 to register, the user 214 can employ one of the social networking services 212 to “follow/subscribe to” the business customer 204 so that the user will receive offers that are part of a campaign implemented by the business customer 204. After submitting the requisite information via the registration component 216, which have been validated for accuracy (e.g., all required fields are complete), the corresponding user data can be written into the data store 210. The registration component 216 can also provide the user 214 with a confirmation (via the selected contact method or other means) that the user has registered.

After a user has been registered for a given first business customer, invitations to register to receive notifications from other business customers or other campaigns can also be presented to the user. Thus, a user can be provided an opportunity to receive notifications that contain offers for various campaigns based upon the user's contact information stored in the data store 210. A profile for each user 214 is stored in the data store 210, which can include a user's identification, a list from which business customers each user has opted to receive notifications as well as pertinent contact information.

The campaign manager 208 is also programmed for implementing the campaign based upon campaign parameters provided by the business customer 204 for the respective campaign. As described herein, a campaign can be initiated automatically at a predetermined time or manually activated by personnel of the business customer 204, such as for implementing an ad hoc campaign. Content data for a given campaign can be stored in the common data store 210. The campaign manager 208 thus can include a campaign engine that executes instructions for a given campaign, evaluates campaign parameters and, based on established rules, sends notifications to each of a plurality of registered users via the corresponding social networking services 212. To facilitate communication of notifications via the social networking services 212, the campaign manager 208 the management system 202 can be programmed to include interfaces for directly accessing the social networking services 212. Alternatively, the campaign manager 208 can employ another service (e.g., Hootsuite, a Twitter client available from Invoke Media, Inc. of Vancouver, British Columbia, Canada) to manage and send the notifications to the plurality of social networking services 212. A given user can register to receive notifications on one or more device and by different communication methods according to a type of social networking service(s) elected for receiving the notification.

During a campaign for a given business customer 204, each registered user can receive content defined by the given business customer. The content can include information about one or more offerings. The notification also includes an offer code for the respective campaign. That is, a unique offer code can be generated for each campaign that can be utilized to track the campaign.

The campaign manager 208 also provides a unique campaign code for a given campaign to one or more POS systems. The offer code that is sent to registered users can be generated based on the unique campaign code. As one example, the campaign code can be a combination of a business customer's 204 customer designator (e.g., a unique identifier for the customer in the platform 200) and a randomly generated alphanumeric code. These two elements, the customer designator and the randomly generated character code, can be combined to form the unique alphanumeric campaign code.

Additionally, the campaign manager 208 can be programmed with corresponding interfaces for each POS device 222 at which users can redeem or conduct transactions corresponding to the offer notification received by such users. The interfaces are programmed according to information (e.g., location and POS specifications) entered by the business customer 204 and stored in the data store 210.

In the example of FIG. 2, a POS server 220 is coupled to the network 206 for receiving and transmitting data therefrom. The POS server 220 can also be communicatively coupled to any number of one or more POS devices 222. Each POS device 222 can include hardware and software programmed and configured for fulfilling financial transactions for products and services, including those specified in the notifications sent during a given campaign. For example, one or more of the keys of the POS devices 222 can be programmed in response to the campaign tracking code, which can be utilized for redeeming the offer by each registered user. For instance, a given user can present (e.g., verbally, visually or otherwise) an offer code to a person operating the POS device, which can be entered at the POS device to accept the offer and purchase the designated good and/or services. The information associated with each transaction that occurs as part of the campaign (as indicated by the user presenting an offer code) can be uploaded to or retrieved by the campaign manager 208 and stored in the database 210 associated with the corresponding campaign.

The management system 202 can also include one or more order module 224 that is programmed to receive and process orders from a registered user on behalf of one or more business customers. The order module 224 thus can include an interface for the POS system similar to those described with respect to the campaign manager 208, although providing for additional functionality of automatically placing an order in the POS system.

By way of example, the order module 224 can be programmed to present a series of web pages that may include an interactive menu that is presented to the user 214 based upon menu data stored in the data store 210. The interactive menu thus can be utilized by a registered user to place an order and purchase goods and services. The order module 224 can send the order to the POS server 220 via the network 206 or store the order information in the data store 210 and send a notification to the POS server 220 to retrieve the order. The presentation of the menu and ordering process can be implemented via secured communication channels as is known in the art.

As one example, the order can correspond to a pre-order that is submitted by the user 214 in advance of a prescheduled event (e.g., a sporting event, a concert, a show or the like). Alternatively or additionally, the order can correspond to an in-event order that is placed by the registered user via a mobile device during an event. Appropriate start and stop times during which each such order can be placed (for in-event ordering as well as pre-event ordering) can be defined in parameters for each respective campaign. That is, the parameters and rules for each respective campaign can be stored in the data store 210.

Additionally, when an order is ready for pick-up at the event, the POS server 220 can send an alert notification to the order module 224 of the management system 202 to trigger a corresponding message to be sent to the user 214, such as via a text message or other substantially real-time messaging. The message thus can inform the user that an order is ready or will be ready in the near future, such that the user can go to the designated pick-up location to retrieve the order. The order can be paid for at pick-up or in advance when the order is placed.

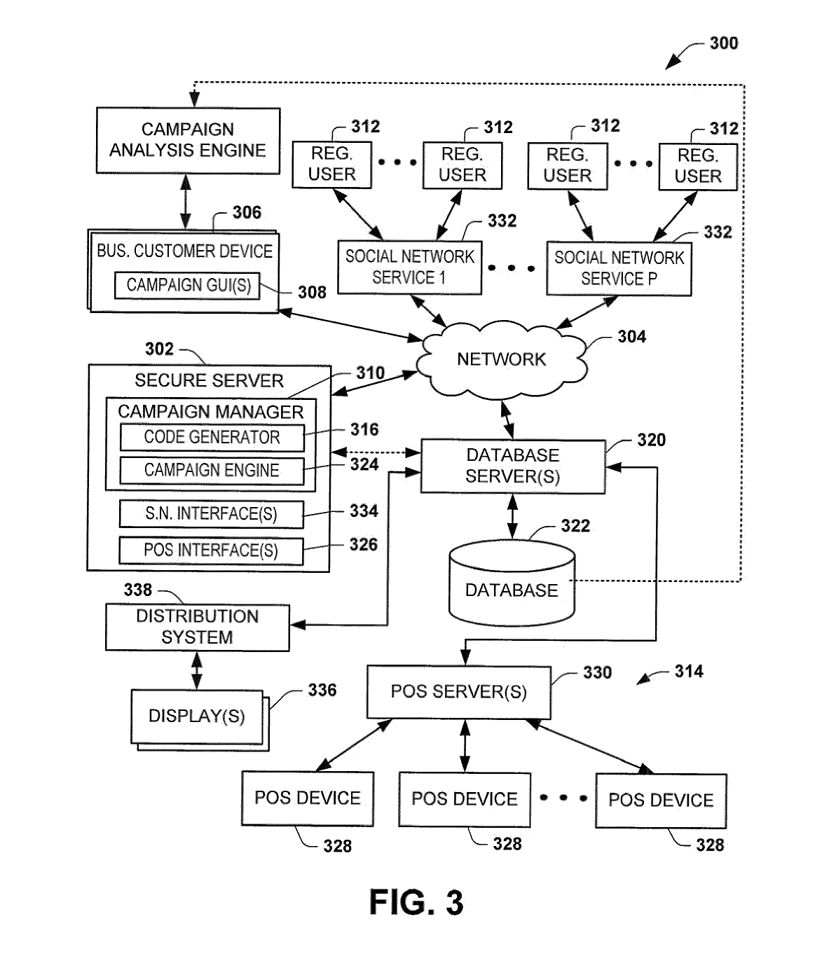

FIG. 3 depicts an example of a platform 300 that can be utilized for implementing a social networking marketing system according to an aspect of the invention. In the example of FIG. 3, it is presumed that each business customer that desires to implement a campaign has been registered with the platform such as described with respect to FIG. 2. Registration of the business customer thus provides information for each respective business customer, including customer account information, infrastructure information (POS information, access codes) in the platform 300 and other relevant information that can be utilized for implementing a campaign. The platform 300 utilizes one or more secure server 302 that is programmed with functions and methods for creating and managing campaigns for any number of business customers. There can be any number of one or more such secure servers 302 which can be shared among the plurality of business customers or, alternatively a business customer can have its own secure server operating in the platform 300.

The secure server 302 can be accessed via a secure communication channel through a network 304, which can include a local area network, a wide area network or a combination of network types. The network 304 can involve physical connections (e.g., electrical connections, fiber optic connections as well as combinations thereof) as well as wireless connections. A business customer device 306 thus can connect to the secure server via the network 304 using a corresponding secure communication channel as is known in the art.

The secure server 302 can serve the customer device a corresponding campaign GUI 308 through which the business customer can interact with the platform 300. The campaign GUI 308 can provide a series of screens and forms that a given business customer can utilize for creating and managing any number of one or more campaigns. The campaign GUI 308 thus accesses functions and methods programmed on the server 302 for controlling creation and execution of each campaign.

For example, a campaign manager 310 can be programmed to create a campaign for a given business customer as well as manage its implementation by sending out corresponding notifications and other information as specified by campaign data. The recipients of the notifications can include any number of one or more registered users 312 as well as one or more POS systems 314.

The campaign GUI 308 can include a series of graphical or text base user interface elements (e.g., radio buttons, tabs, text fields) that can be activated in response to a customer user input. A given user interface element can be activated, for example, to create a campaign for a given business customer. The campaign manager 310 can present the requesting customer a web based form or other document having a plurality of fields for entering corresponding information. Additional user interface elements can be provided for attaching other types of data, such as content (e.g., video, text, graphics and the like) that can be distributed as part of a respective campaign.

In response to creating a campaign for a given business customer, the campaign manager 310 includes a code generator 316 that is programmed to generate a unique tracking code for the respective campaign. The unique code can be created in a variety of different ways to facilitate tracking commercial activity relating to the campaign. As one example, the unique campaign code can be generated as a combination of a unique customer identifier and a randomly generated number (e.g., a plurality of characters, such as 16 alphanumeric characters).

The secure server 302 further can utilize one or more database servers 320 for storing campaign data in and retrieving corresponding data from an associated database 322. The database server 320 can be programmed to control the creation, maintenance, and use of the database 322. The database can be implemented a desired database model, such as relational or object oriented model. The code generator 316 can thus generate the unique campaign code, which is stored as part of the respective campaign data in the database 322. The secure server 302 can access the database server 320 via the network 304 via a corresponding secure communication link, or directly over a connection such as a local area network (indicated by dotted line) or other type of communication link.

The campaign manager 310 also includes a campaign engine 324 that is programmed for implementing a campaign based upon the campaign parameters stored in the database 322. Various types of information can be specified for creating a given campaign, which further may vary according to the campaign type (e.g., incentives, contests and ad hoc campaigns). Selection of a particular type of campaign can result in a certain types of information being requested by the campaign manager 310. An example of data that can be specified as part of an incentive campaign is as follows:
CUSTOMER NAME;
CAMPAIGN NAME;
CAMPAIGN TYPE;
BEGIN DATE;
BEGIN TIME;
END TIME;
END DATE;
RECURRING OR ONE-TIME CAMPAIGN; If recurring, frequency of recurrence, including times and dates.
BRIEF DESCRIPTION of campaign;
PRICE POINTS FOR CAMPAIGN, e.g.: buy one get one, specific dollar value, half price, other.
DIGITAL SIGNAGE PARAMETERS—If so, the business customer will specify if they are to provide the graphical and/or video content to be used in conjunction with the campaign.
CAMPAIGN POINT OF CONTACT (POC) WITHIN THE BUSINESS CUSTOMER ORGANIZATION (Defaults to POC information associated with the business customer, but can be changed for individual campaigns). POC information should include name, email address
   Thus, the campaign can specify any number of times or events, each of which can be utilized to trigger distribution of notifications and associated campaign codes to designated recipients thereof. As an example, notifications can be sent to registered users who have requested to receive offers from a given business customer. Additionally or alternatively, the notification can include content and scheduling information for presenting solicitations or advertisements at designated locations. Additionally, POS data for a given campaign, including a unique code for the campaign, can be sent to the POS system 314.

To enable the secure server 302 to send information to the POS system 314, the secure server can include one or more POS interface 326. Each POS interface 326, for example, can include an application program interface (API) that has been specified to access selected functions and methods in the POS system 314. The POS interfaces 326 can be implemented to accommodate a plurality of different systems, which vary according to manufacturer and device. The POS interface 326 thus can include the requisite program code to access functionality in one or more POS device 328, such as to process transactions associated with the offer and offer code that was generated via the code generator 316. Additionally or alternatively, the POS interface 326 can allow one or more keys to be programmed for ringing up the transaction associated with the respective offer at the POS device.

The business customer can also specify address data or other resource location data to control where the campaign code and POS control data is transmitted. Such address data or other resource location data can be stored in the database 322 as part of the business customer's profile and/or as part of campaign data for a given campaign. Thus the campaign engine 324 can access the stored information and utilize the POS interface to deliver the campaign code and other control information to the POS system 314. The campaign code and other control information can be sent to the POS system in advance of the campaign or when the campaign begins.

It will be understood and appreciated that if a POS system is not accessible via the network 304 or by another direct connection accessible by the secure server 302, the campaign engine 324 can be programmed to send the campaign code and related control information via email or other communication methods to a specified point of contact for the business customer. Appropriate personnel can thus manually install the campaign code and control information in a POS server 330 to which the POS devices may be attached. As yet another example, if each POS device 328 is not coupled to a POS server 330, as in the example of FIG. 3, but is standalone device, such information can be programmed manually for a given campaign according to the programming requirements thereof. Thus, those skilled in the art will understand and appreciate that the manner in which campaign codes and control information for implementing a given campaign are programmed into each POS device 328 can vary according to the type of POS device 328 and the POS system 314 in which they are implemented.

The campaign engine 24 is also programmed for sending notifications to each of the registered users 312 based on campaign data stored in the database 322 for each respective campaign. In the example of FIG. 3, the information is delivered to each registered user via social networking service 332, indicated at social networking services 1 through P, where P is a positive integer denoting the number of social networking services (e.g., P>1). The campaign engine 324 can utilize social networking interfaces 334 that are preprogrammed with API's or other information to enable delivery of each notification to the registered user via a specified social networking service 332. For instance assuming that a set of one or more users has registered to receive notifications, the campaign engine can leverage known APIs for each user's preferred social networking service to send campaign notifications to the respective users. The notifications can be sent to the social networking services in a variety of different formats, such as including XML, JSON, RSS, and ATOM.

For an example of where one or more registered user employs Twitter as a preferred the social networking services 332, the social networking interface 334 can employ the Twitter API, which is provided at http://apiwiki.twitter.com/Twitter-API-Documentation and incorporated herein by reference, to send and authorize notifications to be sent as Twitter data. This document provides a set of APIs that can be utilized by the campaign engine (along with similar API's for other Social networking services 332) to send a new notifications to specified registered users 312, by specifying appropriate parameters defined by the respective API. For the example of the direct_messages/new API for Twitter, the campaign engine can create the notification in a corresponding format that specifies each user (screen_name or user_id of the recipient user) and the notification text (within specified character limits). The text field can be utilized to provide the information informing the recipient users of an offering as well as contain an offer code for the campaign. Similar types of notifications can be constructed consistent with the API's developed for the various social networking services (e.g., Twitter, FaceBook, LinkedIn, Bebo or the like) 332.

In order to enable each respective social networking service 332 to deliver notifications to each registered user, each registered user must register or pre-authorize the social networking service 332 to deliver such offers and notifications to the registered users. The authorization can be linked with a given business customer which itself can be registered as a user for each of the respective social networking services 332. The campaign manager 310 or other methods can utilize appropriate social networking interfaces (e.g., APIs) 334 for causing users to become authorized receive such notifications sent by the campaign engine 324 on behalf of its business customers.

For instance, one or more corresponding account for each social networking service 332 can be created by or on behalf of each business customer. Each business customer can provide corresponding account information for the social networking services 332 that is stored as part of its customer profile in the database 322. Corresponding social networking interfaces (e.g., APIs) 334 can in turn be utilized to request authorization for respective users to receive notifications from the respective business customer's social networking account according to authorization rules and protocols for the respective social networking service 332. The social networking service 332 upon confirming that the registered user has pre-authorized the receipt of notifications from the business customer (as specified in the API that includes the notification to the social networking service) will in turn send each registered user the notification. A given social networking service 332 further can provide the notification to one or more type of device depending on the type of social networking service and the manner specified by the each registered user for receiving content from the social networking service.

The campaign engine 324 further can be programmed, based upon the campaign parameters stored in the database 322, to cause content to be displayed on one or more displays 336 as part of a campaign. As an example, the displays can be implemented as digital signs that are programmed to display content at predetermined times according to a schedule, which that can be stored as part of a distribution system 338. The distribution system 338 thus can be programmed to provide content to the one or more displays 336, which collectively form a digital signage system. The displays 336 can be dedicated to providing information related to the campaign. Alternatively, the information presented on the displays 336 can be multi-purpose displays that are utilized for providing other types of content of which information related to the campaign is only part.

The content presented on the display 336 can include textual data, graphical data, video data and combinations thereof, and may be accompanied by audio. The information presented on the displays 336 by the distribution system 338 can be stored in the database 322 as part of a given campaign. The content data can be transferred to the distribution system 338 and stored in local memory to facilitate its display according to a corresponding display schedule. By way of example, the information provided to the displays 336 can be programmed to inform potential users of an upcoming campaign, provide information to encourage users to receive campaigns from a given business customer, or reinforce a campaign that has already begun.

While, in the example of FIG. 3, content for encouraging individuals with the campaign can be provided through a distribution system 338, it will be understood that similar information can be presented as part of a campaign via different types of media including radio, television, web media or the like. Each such media channel further can be scheduled and implemented as part of the campaign, which further can be stored as campaign data in the database 322. The campaign engine 324 thus can initiate the presentation of such media over various types of media channels through communication from the secure server 302 with the other type of media outlet. For instance, such communication can involve scheduling as well as providing content data that is to be processed and displayed as part of an advertisement or other informational content.

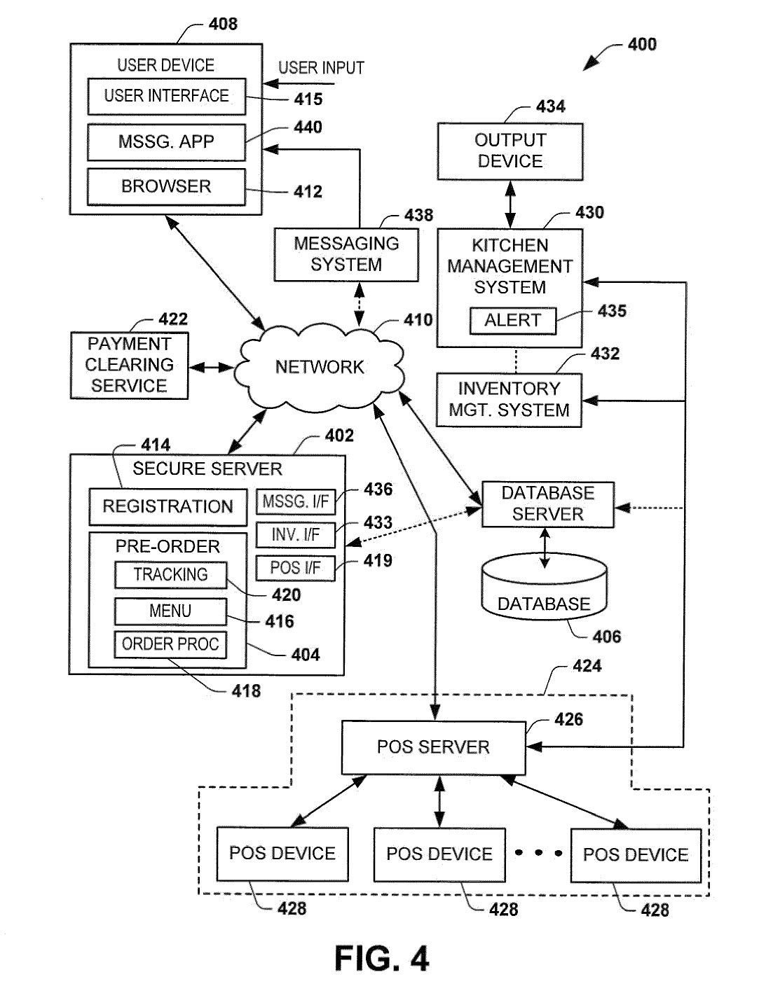

FIG. 4 depicts an example of a platform 400 that can be utilized for pre-ordering of goods and/or services as part of a campaign associated with a scheduled event. Examples of such scheduled event can include a sporting event, concert, conference or other educational or entertainment event that may occur at a venue having one or more POS where goods and services are sold. The platform 400 employs one or more secure server 402 on which a pre-order module 404 runs for managing the ordering process.

The pre-order module 404 includes functions and methods programmed to implement a pre-ordering campaign, such as for receiving and processing orders for food, beverages, and associated services that are to be obtained a predetermined time period before a specified event. Information (e.g., a list of items and prices) associated with a business customer's menu of available food and beverage offerings as well as order information can be stored in a corresponding database 406. The database can be managed by a database server 407, which can be coupled to a network 410 (e.g., LAN and/or WAN). The secure server 402 thus can access the database via the network 410 and database server 407 or a direct communication link can be utilized (indicated at dotted line).

A user consumer can employ a network-ready user device 408 to access the pre-order module 404 via the network 410. For instance, the user device 408 can be implemented as a computer (e.g., a desktop computer, a mobile computer, a laptop or the like) that includes a browser application 412. The user can employ the browser 412 to access a corresponding secure website via a corresponding URL, which can be provided via various methods such as mentioned herein. For instance, a link can be provided via a notification that is sent to the user or be provided via an associated website that includes a resource locator for accessing the pre-order module 404. For example, a user can receive an email or other notification associated with a campaign indicating that a pre-ordering is available for an upcoming event. Alternatively, the notification can include a general link to the pre-ordering module 404, which itself can allow a user to select which upcoming event the pre-order is being requested.

Each pre-registered user will receive notifications that are sent as part of a campaign, such as described herein. Additionally or alternatively, a user can be informed of the pre-ordering event via other types of notifications including advertisements (e.g., via the web, television, radio or print). As an example, an event service company, promotion agency or team can provide a link or other information to encourage individuals to perform pre-ordering. The notification can incentivize users to pre-order (e.g., by offering a discount, shorter lines for pre-orders) instead of purchasing food and beverages in the normal manner at an event.

If an individual is not registered for performing the pre-ordering, a user can employ a user device 408 to access an associated registration module 414. For instance, the user device 408 also includes a user interface 415, such as can include a pointing device (e.g., a mouse, touch screen, touch pad or the like) as well as a keyboard or keypad that can vary according to the type of device. The registration module 414 can provide a secure webpage that requests information for the user sufficient to enable a transaction to occur. The user information can be stored as part of the user's profile in the database 406.

A user can also be pre-registered to initiate the pre-ordering. For instance, the registration information for the user can be stored in the database 406, such as based on a prior order for one or more business customer. Alternatively, an individual user can register when placing a pre-order or a user can proceed without registering, in which case user information will not be stored in the database.

The pre-order module 414 includes a menu component 416 that is utilized to serve one or more corresponding web pages to the browser 412 of the user device 408. The web pages can provide an interactive menu based on menu information stored in the database 406 for a given business customer. It will be appreciated that the menu that is presented to the user's browser 412 can be a full complete menu of offerings available. Additionally, since the order is being place in advance, additional special food and beverage offerings can be provided, which may provide additional enticement to the user for pre-ordering in advance of the event.

As described herein, the pre-order module can be programmed to permit ordering according to a begin time and end time associated with the pre-order campaign. The timing parameters for the pre-ordering can be maintained in the database 406 associated with the business customer and the venue and POS system for which the pre-ordering is being implemented. It will be understood and appreciated that the separate pre-order menu can be provided for each of any number of one or more facilities and/or events via which the business customer wishes to allow pre-ordering to occur. For example, at a sport's venue, a variety of different restaurants and concession areas can be distributed throughout the venue and provide a different variety of food offerings. Each such location can have a pre-order menu that is accessible via a browser 412 for pre-ordering.

The pre-order module 404 also includes an order processing component 418 that is utilized by the menu component to receive and process the pre-order as well as coordinate pre-payment for the order. The order processing component 418 can be utilized to track items selected by the user via the user interface 415 and, in turn, present a running total for items selected during pre-ordering along with the associated costs in a corresponding user interface element (e.g., in a dynamic HTML panel) that is updated in real time. In this way, a given user is presented with a running total of items, quantity and prices for all items selected as part of the order. In this way, as a user may add and remove items the running totals, quantities and prices are modified in the browser 412 accordingly.

Once a user has selected all items that the user wishes to order, the order processing component 418 can initiate fulfillment process for the pre-order. For instance, the order processing component can control processing payment for the pre-order as well as send the order details to a point of sale system via a POS interface 419. To facilitate tracking and processing the order throughout the platform 400, the order processing component 418 can also employ a tracking component 420 that is utilized for tracking each order. The tracking component 420 can generate a unique tracking identifier (ID), which may include a unique portion specific for a given business customer or event along with a unique order number, to facilitate tracking and fulfillment of each order. The tracking ID along with other details for order can be stored in the database 406. Prior to generating the tracking number, and sending the order for fulfillment, a user can pre-pay for the order. That is, the secure server can provide means for processing and paying for the order via a payment clearing service 422 as is known in the art.

In addition to storing the order and tracking information for the order in the database 406, the pre-order module 404 can utilize various other interfaces to facilitate fulfillment of the order. For instance, the secure server 402 can be programmed with POS interfaces 419 to allow communication of relevant information to a corresponding point of sale system 424. The point of sale system can include a point of sale server that communicates with any number of one or more POS devices 428.

The POS server 426 further can communicate with a kitchen management system 430, such as a kitchen display system (e.g., commercially available from Micros Systems, Inc. of Columbia, Md.), which is utilized to present kitchen personnel with information relating to orders that are to be fulfilled. The kitchen management system 430 can also include one or more output device 434, such as a display, a printer, a bumper bar or the like. The output display can be in the kitchen where the food is being prepared and thus can present orders that are received at a given POS device 428 as well as present and display pre-orders such as those made by the user via the user device 408. Thus, the individual's order can be stored in the database 406 and accessed by the POS server 426 and presented to the kitchen management system 430 so that the order can be completed in a timely fashion based upon the specified timing requirements in the pre-order. The coordination of the kitchen management system 430 thus can be controlled based on notifications sent by the pre-order module 404 via the POS interface 419.

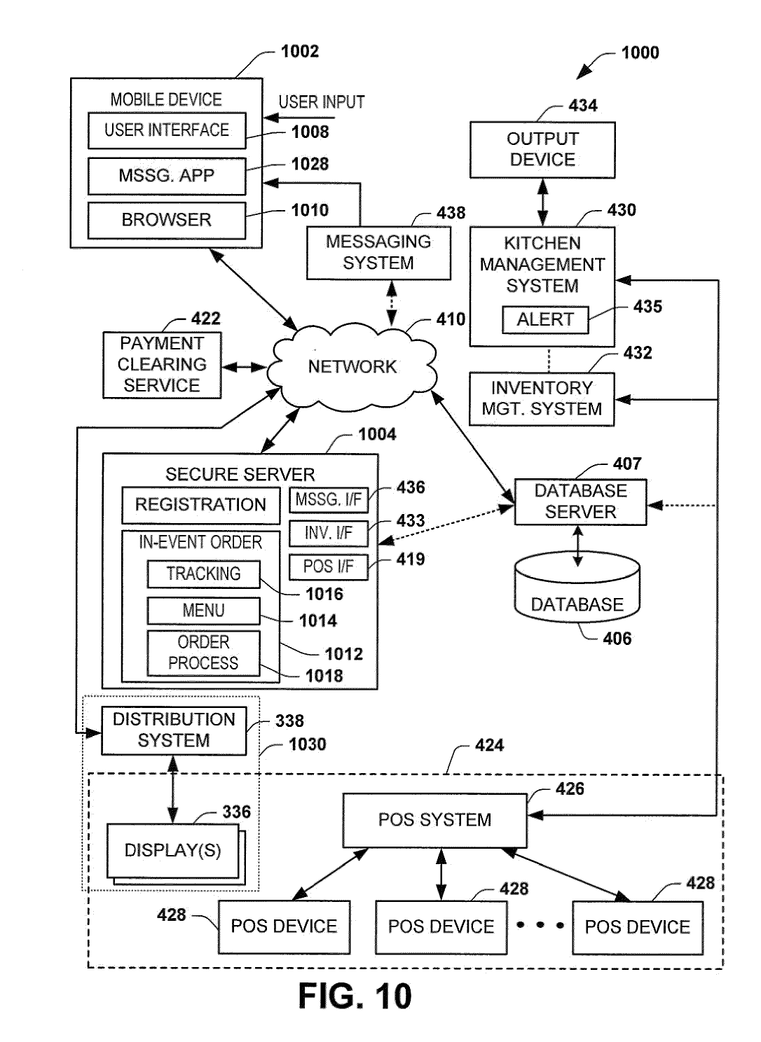

Since the pre-order is implemented prior to the event, the pre-order can be utilized by an inventory management system 432. The inventory management system 432 can be programmed and configured to manage the inventory for the particular venue at which the pre-order was made as well for any number of one or more venues in a given region. Additional features associated with inventory tracking will be discussed herein with respect to in-event ordering of FIG. 10.

The inventory management system 432 can be coupled to and integrated with the POS server 426 or it can be a standalone system that the pre-order module 404 communicates with via an inventory interface 433. The inventory interface 433 can be programmed with APIs to enable updating of projected items for each location based on pre-order data supplied by the pre-order module 404 to the inventory management system 432. Thus, the management system 432 can ensure that sufficient quantities of food items are obtained prior to the event to accommodate not only expected food orders during the event, but also each of the pre-orders that have been placed prior to the event. A user can also elect for a premium option of having the food item delivered to their location in the event. The costs for such service can be determined by the venue and can be free or incur additional charges at the time of pre-order.

The kitchen management system 430 can include an alert function 435 to allow kitchen personnel to identify an order as being complete. When a pre-order has been identified as complete and ready for pick-up (or nearly ready), the alert function 435 can send a corresponding notification. The ready notification can be sent to the POS server 426, which can, in turn, send an order completed signal back to the pre-order module 404 of the secure server 402. Alternatively, the alert function 435 can send the message directly to the pre-order module 404.

The pre-order module 404, in response to receiving the order complete message, can employ a message interface 436 to send a corresponding notification (e.g., a message) to the user. For instance, the messaging interface 436 can send the notification to a messaging system 438 for distribution to one or more predetermined destination that has been specified by the user, such as can be stored in the database 406 as part of the user profile. For instance, the user device 408 can include a message application (e.g., text messaging, email application or the like) 440 that is programmed to receive and present messages from the messaging system 438. The predetermined destination can be associated with a mobile device that also includes a message application (similar in purpose and function to the message application 440) for receiving and presenting the user with a pre-order confirmation. For instance, as part of the pre-order process the user provides contact information (e.g., one or more of an email address, telephone number, or social networking account), which that can be utilized by the messaging system 438 for sending the order-ready notification. The messaging system 438 can relay the notification to inform the user that the pre-order is ready for pick-up. It will be understood and appreciated that the coordination and timing of the order-ready notification can be provided in advance of the order being completed to ensure that the order is fresh by the time user receives the message and goes to pick up the order.

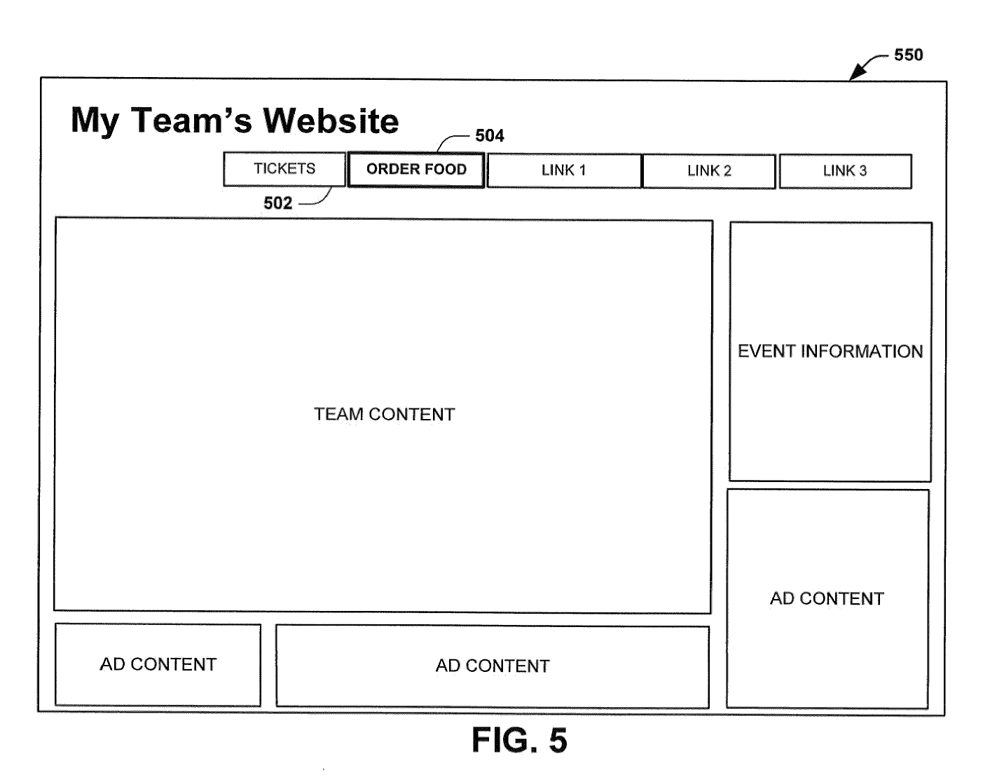

FIGS. 5-9 illustrate examples of user interfaces and user interface elements that can be implemented by corresponding functions and methods to provide a pre-order process. Reference can be made back to FIG. 4 additional information as to how such user interface elements, functions and methods operate in the context of the platform 400.

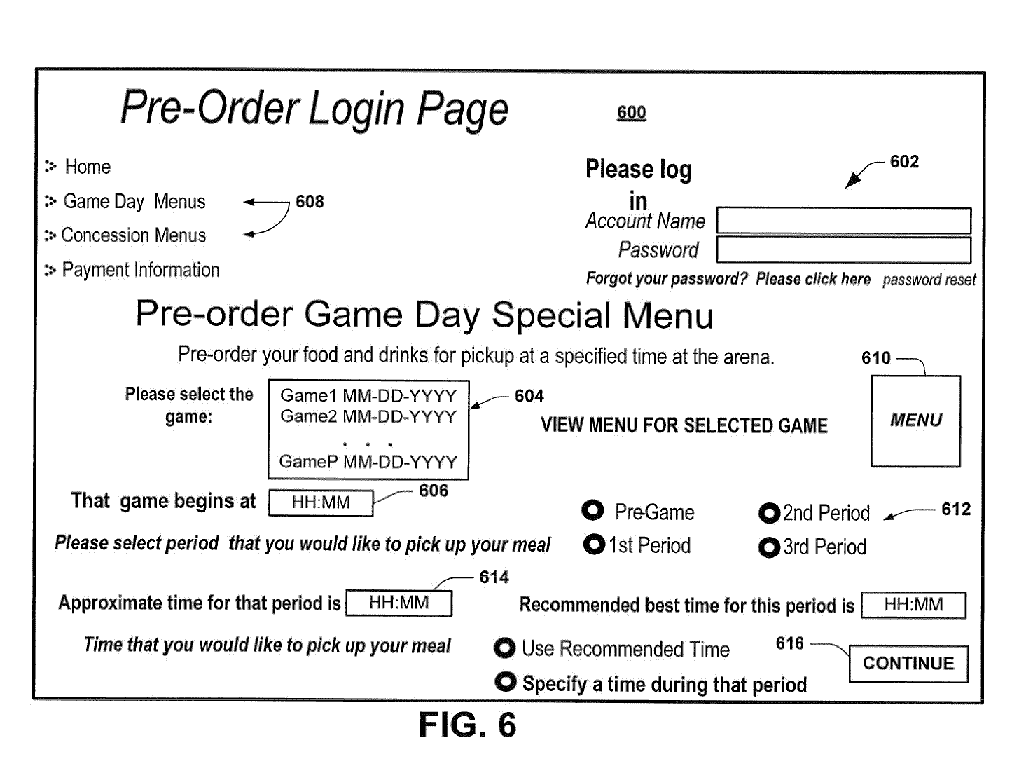

FIG. 5 depicts an example of a web page 500 that can be utilized for accessing the functions and methods provided by the pre-ordering module 404 (FIG. 4). The web page 500, for example, can correspond to a team's website for a sporting event that is to occur in a venue. The website can include a variety of different links and information, such as a link for ordering tickets 502, as well as a variety of other user interface elements and windows that present various content, which can include ads, event information or the like. The web page 500 can also include an “order food” user interface element (e.g. a radio button) 504 that can be activated via a user interface 415 to invoke the pre-order module 404 (FIG. 4). For instance, activation of the “order food” user interface element 504 can send the user to a second URL via a secure server 402, such as a pre-order log-in web page shown in the example of FIG. 6.

As shown in FIG. 6, the pre-order log-in web page 600 can be served by the secure server 402 (FIG. 4) to provide a user a variety of user interface elements for use associated with the pre-ordering process. As described herein, a link to the pre-order login page can be provided in another web page (web page 500 of FIG. 5) or in a notification, such as can be sent as part of a campaign.

The login web page 600 can be similar to a normal login to a secure server (server 402 of FIG. 4) as in known in the art. For instance, the pre-ordering the log-in page 600 can provide log-in user interface elements 602 in which a user enter the user's account name and password. Additionally, the pre-order log-in page 600 can allow a user to select the event for which the pre-ordering is being implemented. For instance, a dialog box or other user interface element 604 can present the user with a set of available selections for a given event, which may identify the event by month, day and year or other recognizable identifiers. For the example of a game that has been selected by a user via user interface element 604, a game start time can be presented in a corresponding dialog box 606.

Depending on the venue there can be any number of one or more of restaurants or concession areas for which pre-ordering may be implemented. Corresponding menus for each of these venue locations may be accessible via associated “menu” user interface element 610. Additionally, it will be understood and appreciated that a pre-ordering menu user interface element 610 can access various pre-order menus that can vary from game to game according to offerings being made available. Accordingly once a game has been selected via the user interface element 604, a corresponding menu may be selected via the user interface element 610.

The menu user interface element 610 can present the user with one or more available menu for a given restaurant or concession area. The menu or menus for the selected game can be presented in a new window or a tab in the corresponding browser of the user device. Also associated with the log-in page a user interface element 612 can be used to select a time for picking up the pre-order, although this can be set at any point during the pre-order. For instance, the time can be specified relative to the game start time or by one or more selected relevant time periods, which may vary according to the type of event. For the example of a basketball game, food pick-ups can be pre-ordered for before the game (pre-game), a first quarter, a second quarter or a third quarter.

It will be understood and appreciated that pre-orders for a given event can be restricted to one or more time intervals or portions of a respective event. Moreover, rules for a given venue, such as alcohol sales, can be implemented to restrict ordering of such food items depending on and consistent with the venue policies and applicable laws. In addition to specifying a period or quarter of the event during which the item is to be selected via the user interface elements 612, an approximate time for that period relative to the start time 606 can be presented in another dialog box 614. Based upon expected concession activity, which can be established by the business customer, the pre-order module can present the user with a recommended best time for pick-up consistent with the expected activity at the restaurant or concession area where the item will be picked up. After the appropriate items have been selected, a user may continue the pre-order via a “continue” user interface element 616.

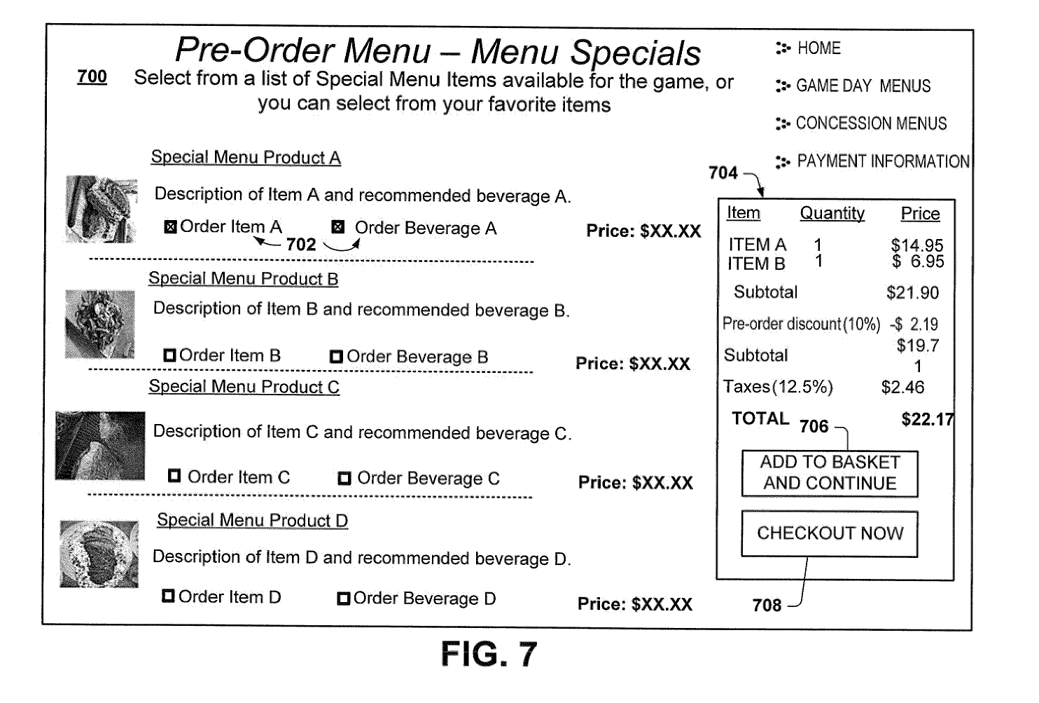

FIG. 7 depicts an example of a pre-order menu user interface page 700 that can be served to a user as part of the pre-ordering process. The pre-order menu page 700 can have a format and appearance dictated by the business customer and the restaurant and/or food station for which the menu is being prepared. In the example of FIG. 7, the pre-order menu web page 700 presents a plurality of menu options, each of which can be selected via a corresponding user interface element 702. For instance, special menu items can be presented along with recommended beverages which a user can select and update quantities via the pre-order menu user interface elements 702.

Additionally, the pre-ordering menu user interface 700 can provide an order display window user interface element 704. The order display user interface element 704 can provide an itemized list of items selected, quantity of items, as well as their price. A running cost total can also be presented via the order display element 704. The information in the order display element 704 can be updated in real-time (or near real-time) based upon the selected items. Associated with the pre-order, can also be a pre-order discount (e.g., 10% in the example of FIG. 7) that can be subtracted from the total cost of the pre-order. The pre-order discount thus affords an advantage to pre-ordering in place of ordering during the event or using the ordinary concessions.

Additionally, special menu selections can be provided that would not otherwise be available to the consuming public at the event. It will be understood and appreciated that a pre-order can be utilized with respect to more than one menu. For instance after items from a given menu have been selected, such items can be added to the basket and continue shopping via the corresponding user interface element 706. If the user has completed the order in wishes to purchase the items in advance as part of its pre-order, a “checkout now” user interface element 708 can be activated.

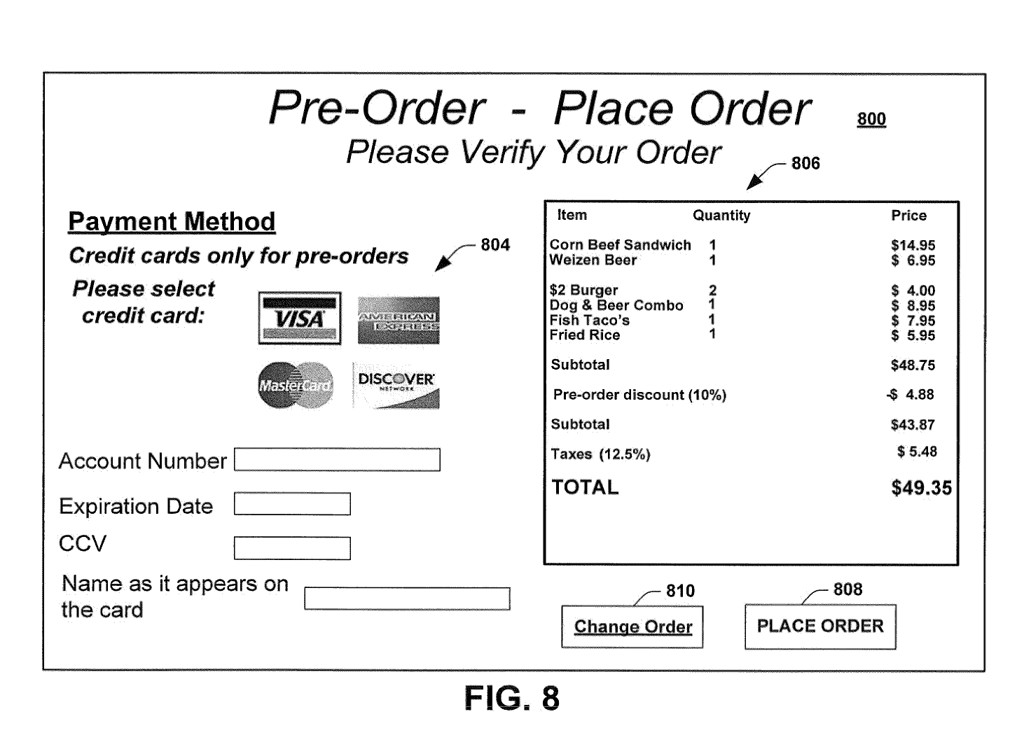

Once the user has decided to check out and complete the purchase the items specified in the pre-order, the user is served up an order placement web page 800, such as shown in FIG. 8. The order placement web page 800 can include a plurality of user interface elements and fillable fields, such as including a “payment method” user interface portion 804, which can include fillable fields for providing credit card account information (e.g., number, expiration date, code and account name). An order display element 806 can be presented adjacent the payment information user interface elements 804. The order display element 806 lists each of the items that the user has selected as part of its pre-order, which may include items from any number of one or more menus. Thus each item, quantity and price as well as discount, taxes and other charges can be identified in the order display element 806. A user at this stage has an option of paying for the order based upon the payment method implemented in the payment user interface element 804, such as by selecting the “place order” user interface element 808 or an order can be changed via a “change order” user interface element 810.

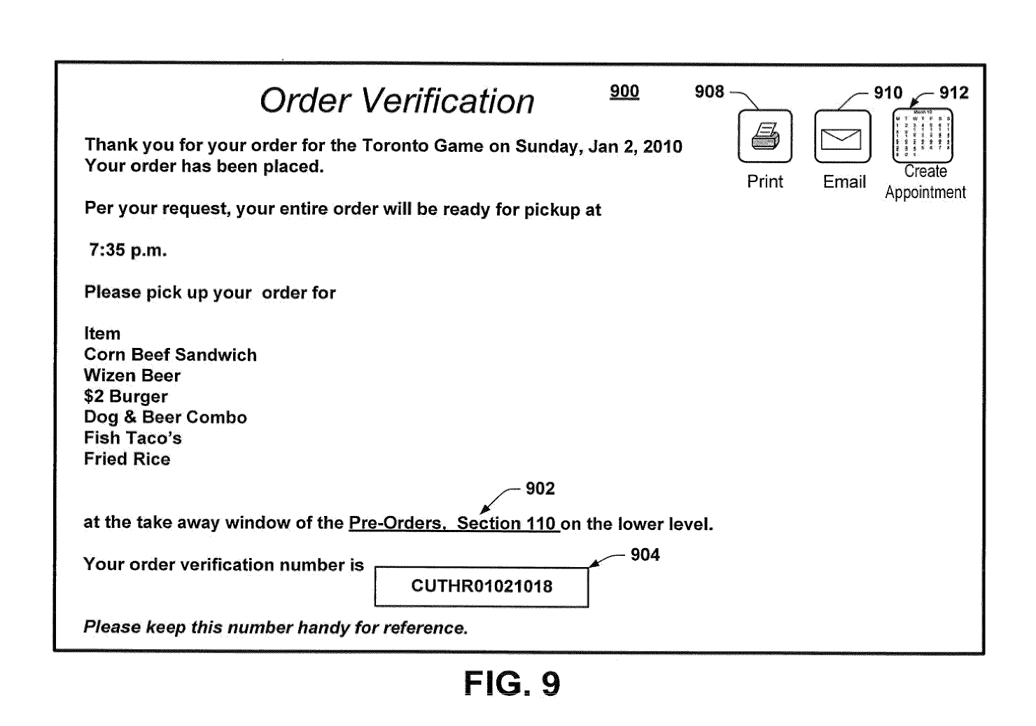

When the pre-order has been paid for using the credit card information (e.g., via selecting the “place order” user interface element 808 of FIG. 8), a user can be served an order verification web page 900, such as shown in FIG. 9. In the example of FIG. 9, order placement information can be presented to the user for the pre-order along with an identification of a location when and where the pre-order is to be picked up. The order pick-up location can be presented in a display element 902, which can be populated with venue-specific location information. Additional information associated with the pre-order, including an itemized list of the items and a time for pick-up, can also be provided as part of the order for verification web page 900.

As described herein, a unique order verification number can also be provided (e.g., by the tracking component 420 of the pre-order module 404 of FIG. 4) in a display window 904. The order verification number corresponds to a tracking number that is utilized by a POS system (e.g., system 424 of FIG. 4) for fulfilling the pre-order. This order verification number can be printed or sent to the user via other electronic means as part of the verified order, such as according to messaging techniques shown and described herein.

By way of further example, the order verification web page 900 can include user interface elements 908, 910 and 912 that are programmed for accessing APIs to perform certain actions relative to the order verification. For instance, a print user interface element 908 can be provided to print a hard copy of the order verification. Additionally, an email user interface element 910 can be utilized for employing an email application for sending an email to an individual, such as to the user who placed the order or another individual for which the order has been placed (e.g., as gift). Thus, the order verification number provides a receipt that can be used by any person to pick-up or redeem the pre-order. Additionally, an appointment user interface element 912 can be created based on the time and date at which the pre-order is to be ready, which can pop-up via a mobile device that the user may have at the event. Those skilled in the art may understand and appreciate various ways in which the order verification can be utilized and tracked by the user.

FIG. 10 illustrates an example of a platform 1000 that can be utilized for implementing an in-event ordering via a mobile device 1002. The mobile device 1002 can be any internet-ready device that can access a secure server 1004 via a network 1006. For instance, the network 1006 thus can include a LAN, such as a WLAN operating in the venue where the event occurs, a wide area network or a combination of local area networks and wide area networks. It will be understood that much of the platform 1000 is similar in configuration to the platform 400 of FIG. 4 and the platform of FIG. 2, but has been specifically demonstrated in the context of an in-event ordering system implemented at a server 1004. Thus, for sake of consistency and simplicity of explanation, corresponding parts previously introduced herein, including parts shown and described with respect to FIGS. 3 and 4, are represented in FIG. 10 by the same reference numbers. Accordingly, additional information about such common components can be obtained by reference back to the corresponding description of such components with respect to other figures.

In the example of FIG. 10, the mobile device 1002 can wirelessly communicate with the server 1004 via the network 1006, such as by one or more of a cellular data network connection, a WiFi network connection, a WiMax data connection or any other form of wireless data communication. For instance, the mobile device 1002 can include a wireless interface that is configured to enable such data communication. The mobile device 1002 can include a user interface 1008 and browser application 1010 that cooperate to enable interaction between the user, in response to user inputs, and an in-event order module 1012 running on the server 1004.

The in-event order module 1012 can be programmed to include many of the components similar to those shown and described in the pre-order module 404 of FIG. 4. For instance, the in-event order module 1012 includes a menu component 1014, a tracking component 1016 and an order processing component 1018. While each of these components 1014, 1016 and 1018 may be programmed with the same or substantially similar functions and methods as the corresponding components 416, 420 and 418 (FIG. 4), however, a different set of parameters and rules control their operation during an event. The parameters, for example, can define a begin time and an end time at which in-event ordering can be enabled. The begin time and an end stop time can be defined relative to the event itself, which may vary according to circumstances relating to the event.

Additionally, since in-event ordering will occur over a mobile device 1002, in contrast to possible more robust systems via which pre-ordering may be implemented, the order module 1012 can be programmed to provide corresponding services as a .MOBI top level domain. That is, the in-event module and its associated web-pages provided by the secure server 1004 can be optimized for viewing on mobile devices. Additionally, the in-event order module 1012 can provide another version of services via traditional methods that can be more. That is, the in-event order module 1012 can provide separate (and somewhat redundant) device-dependent versions of its services: one desktop-based and the other mobile-based.

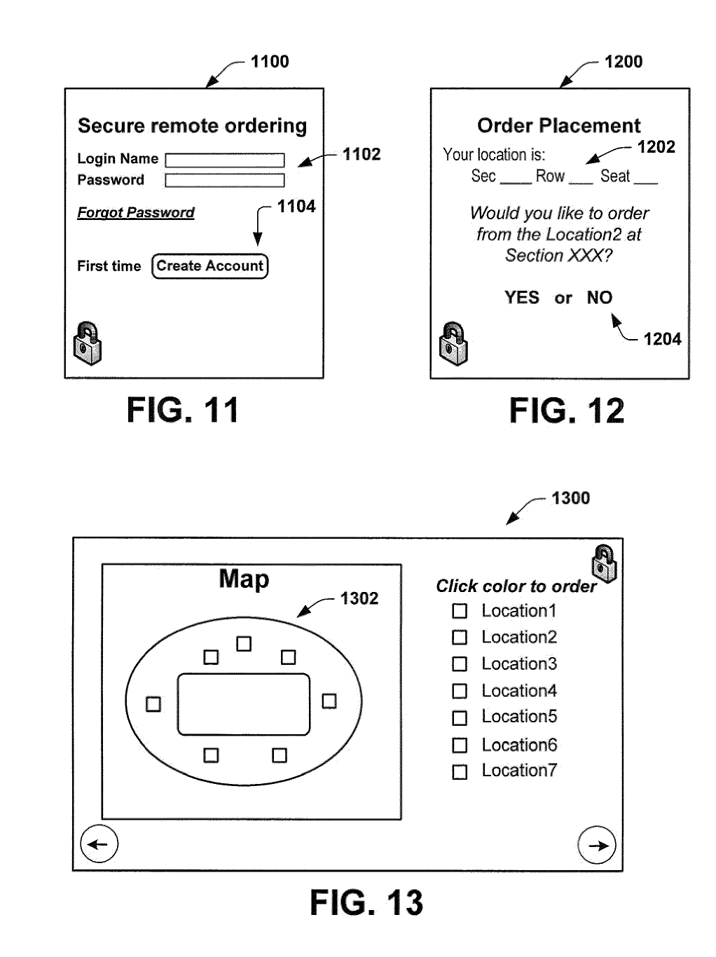

Examples of how the platform 1000 can be implemented in the context of the in-event order module 1012 will be better appreciated with reference to FIGS. 10-15. FIGS. 11-15 depict examples of mobile web user interfaces that can be presented by the secure server 1004 to the mobile device 1002 via corresponding network 1006, which can be optimized for mobile device (e.g., in the .MOBI domain) or be implemented as traditional web pages.

FIG. 11 depicts an example of a user interface 1100 that can be presented to a user on the mobile device 1002 as part of a login for secure remote ordering via the server 1004. In addition to logging in for users who have previously created an account (and thus a user profile stored in the database 406), a user can also access create or append an account for in-event ordering. For instance, the user interface 1100 can include a user interface element 1104 that accesses functions and methods to create an account. The user profile can include data sufficient for ordering, tracking orders as well as for fulfilling financial end of the transaction and confirming the transaction with the mobile device 1002.

Referring to FIG. 12, as part of the order placement process, a user can be presented a user interface 1200 through which users can specify their location (e.g., by entering section, row or seat number). Alternatively or additionally, a user has an option, if supported by the venue, to opt in, which can be defined as part of the user's profile, to location services. The location services can be utilized to ascertain a location of the user (e.g., via GPS, cellular base station triangulation, WLAN access points or the like) as is known in the art. Based upon the location information for the user, which can be entered via user interface elements 1202 or otherwise determined, a set of proposed locations can be presented to the user, such as corresponding to the most nearby location or set of locations from which a user can order. These results can present an option as part of a GUI, which can be activated for ordering from such one or more locations via the user interface 1200. For instance, the user can select whether to proceed in this option via selecting one of the presented user interface elements 1204 (YES or NO).

Additionally or alternatively, as depicted in FIG. 13, a user can be presented with a location user interface 1300 that can include a map GUI 1302 of the venue which can depict and identify locations (indicated at “location 1” through “location 7”) for which in-event ordering can be implemented. A user thus can employ the map GUI 1302 to select a desired location for which a menu GUI can be generated. In response to such user selection, a user may also be presented with a user interface element requesting confirmation of whether the user would like to receive a menu associated with a selected location or by location that has been determined based upon location information for the user.

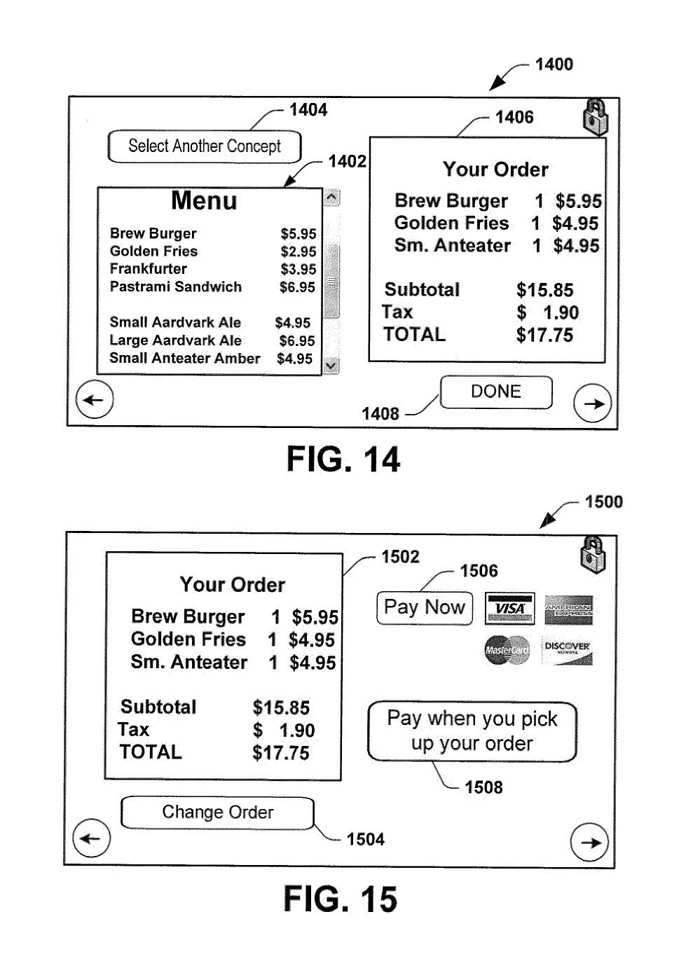

Once a user has selected the corresponding location for order, a user can be presented with a menu user interface element 140, such as shown in FIG. 14, which can be provided by the secure server 1004. The menu user interface element 1400 can include an interactive menu user interface element 1402 that can present an interactive list of items and corresponding prices. If the user does not wish to order from the items presented in the menu user interface element 1402, a user can activate another user interface element 1404 to select another concept or location for which a user will be presented another menu user interface element.

Adjacent the menu element 1402 can be an order dialog user interface element 1406 that presents the user with an itemized list of order items selected and quantity and cost for each item as well as any applicable taxes and service charges. The itemized list thus can provide the user with real time feedback to facilitate the ordering process on the user's mobile device 1002. Once an order has been completed, a user can select a “done” user interface element 1408 to indicate that the order has been completed.

As shown in FIG. 15, a payment user interface 1500 can be presented to the user to complete the process. The payment user interface 1500 can access functions and methods for clearing payment for the in-event order, which can employ a payment clearing service 422. For instance the payment user interface 1500 can provide a confirmation of the in-event order in a “your order” user interface element 1502, which can display each of the items ordered, their price as well as a total therefor.

Additionally, if the user wishes to change the order the user may be done by selecting the corresponding “change order” user interface element 1504. If the user is satisfied with the order and wishes to complete the purchase, the user can select to either pay for the items via the secure payment clearing service 422, such as by selecting a pay now user interface element 1506, or a user can select to pay when you pick up the order such as by selecting the user interface element 1508. In either situation, the vendor can request credit card information that can be charged in the event that the user, after having placed the in-event order, does not pick up the order.

After the user has completed and placed the order either by selecting pay now and completing the payment options or pay when picked up, a corresponding order can be saved in the database 406 and appropriate notification sent to the point of sale system 424 for order fulfillment. An order thus can remain open until the order has been picked up by the user.

Similar to as shown and described with respect to the pre-order, once an order has been completed or has been near completion, an appropriate alert notification may be sent by the kitchen controller that is routed back to the in-event order module 1012. The in-event order module 1012 upon receiving the notification can in turn send a message or other notification via the messaging system 438 to the user's mobile device 1002 to inform the user that the order is ready for pick-up. The manner through which the notification is made can be preconfigured based upon preferences of the user, which are stored in the user profile in the database 406. The preferences, for example, can include calling a mobile number, sending a text message, an email, or a combination of notification methods may be implemented.

The platform 1000 can also utilize a digital signage system 1030, which can include one or more displays 336 and a corresponding distribution system 338, such as shown and described with respect to FIG. 3. The digital signage system 1030 can be employed as part of a campaign to motivate users (e.g., registered users and potential users) to utilize the in-event ordering process. As one example, a campaign manager can be utilized to implement an ad hoc campaign during an event, such as in the case where a business customer has noticed an increased inventory of certain items, which can across locations or be specific to one or more locations at the venue. The ad hoc campaign can thus send a notification of offerings that provide incentives to the users to purchase such items, which purchases can be made via the in-event order module 1012 or via other purchase methods, such as disclosed herein.

In view of the foregoing, those skilled in the art will understand and appreciate that a common platform can be utilized for each of the respective campaigns, including the social network marketing campaign, pre-ordering campaigns as well as the in-event campaigns. That is, each of the servers 302 and 402, and 1004 can include any one or a combination of the campaign manger module, the pre-order module and an in-event order module for implementing corresponding functionality, as shown and described herein.

What have been described above are examples and embodiments of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications and variations that fall within the scope of the appended claims and the application.

What is claimed is:

1. A method for implementing a campaign, comprising:
registering in a database each of a plurality of registered users to receive notifications sent on behalf of a business customer;
creating a given campaign for the business customer by storing campaign data that parameterizes at least timing and content for the given campaign; and
in response to determining to begin distribution of the campaign based on the campaign data:
sending a unique campaign code associated with the given campaign to a point-of-sale (POS) system to enable tracking of financial activity motivated by the campaign; and
causing at least one notification to be sent to each of the plurality registered users about the campaign, the notification comprising an offer code that is based on at least a portion of the unique campaign code associated with the given campaign.

2. The method of claim 1, further comprising receiving a campaign request from the business customer for creating the given campaign, the campaign data being derived from the campaign request.

3. The method of claim 2, wherein the campaign data comprises a campaign schedule having a start time and an end time, at least one of the unique campaign code and the notification being send based on the campaign schedule.

4. The method of claim 1, further comprising generating the offer code and a validation code based on the unique campaign code.

5. The method of claim 4, further comprising providing a given registered user the validation code in response to the given registered user presenting the offer code as part of a transaction involving the offer code.

6. The method of claim 1, further comprising packaging the campaign data in a predetermined format to enable receipt and distribution of at least a portion of the campaign data by at least one social networking service, the at least one social networking service sending the notification to each of the plurality registered users that have authorized receipt of notifications from the business customer within the at least one social networking service, the notification corresponding to the at least a portion of the campaign data.

7. The method of claim 1, wherein registering comprises storing contact information for each of the plurality of registered users in the database as part of a user profile for each respective registered user, the contact information including an identifier for enabling communication with each of the plurality of registered users via at least one specified social networking service to which each respective user is pre-registered.

8. The method of claim 7, wherein the at least one specified social networking service, to which each respective user is pre-registered, stores social networking profile for each respective registered user, the stored social networking profile for each respective user includes authorization data that determines if the notification is sent to each registered user on behalf of the business customer.

9. The method of claim 1, wherein the notification is sent to at least one specified social networking service on behalf of the business customer via a pre-programmed social networking interface, the at least one specified social networking service distributing the notification to at least a subset of the plurality of registered users that have authorized the at least one social networking service to deliver notifications on behalf of the business customer.

10. The method of claim 1, further comprising transmitting campaign content data associated with the at least one campaign for presentation on at least one display device that is controllable by the business customer.

11. The method of claim 10, wherein the content data comprises at least one of textual, graphical and video data, and
wherein the at least one display device comprises a digital signage system.

12. The method of claim 1, wherein the campaign data comprises temporal data that defines when the campaign begins and ends, and
wherein each of the notification and the unique campaign code are sent based on the temporal data.

13. The method of claim 1, further comprising receiving an order from the given user for at least one of goods and services, the order being responsive to the notification for the given campaign.

14. The method of claim 13, wherein given user presents the offer code as part of the order to facilitate tracking the given campaign by the business customer.

15. A system for managing a campaign, comprising:
a campaign manager, the campaign manager comprising program instructions executable by a server for performing a method that comprises:
storing campaign data in a data store in response to a request from a business customer, the stored campaign data comprising rules for implementing at least one given campaign on behalf of the business customer; and
sending a campaign code associated with the at least one given campaign to at least one point-of-sale (POS) system to enable tracking of transactional activity related to the at least one given campaign; and
causing at least one notification to be sent to each of a plurality registered users about the at least one given campaign, the notification comprising an offer code that is part of the at least one given campaign;
the POS system being configured to conduct a transaction involving presentation of the offer code by a given one of the registered users within the at least one given campaign.

16. The system of claim 15, wherein the server further comprises at least one interface programmed for providing the notification to at least one social networking service, the at least one social networking service sending the notification to a subset of the plurality of registered users that have authorized the at least one social networking service to deliver notifications to respective users on behalf of the business customer.

17. The system of claim 16, wherein the data store includes a user profile for each of the plurality of registered users, each given user profile specifying which of the at least one social networking service to utilize for delivering each notification on behalf of the business customer.

18. The system of claim 17, wherein each of the plurality of registered users is registered with the at least one social networking service, each of the at least one social networking service maintaining a social networking profile for each respective registered user, the social networking profile for each respective user includes authorization data that determines whether or not the notification is sent to each registered user on behalf of the business customer.

19. The system of claim 15, further comprising:
at least one digital display that is configured to provide at least one visual content and audio content that is viewable by a public audience; and
a distribution system that controls content provided on the at least one digital display, the server controlling content that is sent to the distribution system for display based on the stored campaign data.

20. The system of claim 15, further comprising an order module that includes program instructions executable by the server for performing a method that comprises:
receiving an order from a given user, the order being placed by the given user responsive to the notification for the at least one given campaign; and
providing feedback to the given user that the order is ready, the feedback being provided to the given user according to contact information specified in a user profile stored in the data store for the given user.
